(19) United States
(12) Patent Application Publication
(10) Pub. No.: US 2013/0222639 A1
(43) Pub. Date: Aug. 29, 2013

(54) ELECTRONIC CAMERA

(71) Applicant: SANYO ELECTRIC CO., LTD., (US)

(72) Inventor: Tomoki Oku, Osaka-shi (JP)

(73) Assignee: SANYO ELECTRIC CO., LTD., Osaka (JP)

(21) Appl. No.: 13/773,084

(22) Filed: Feb. 21, 2013

(30) Foreign Application Priority Data
Feb. 27, 2012 (JP) 2012-040282

(51) Int. Cl. H04N 5/232

(52) U.S. Cl. CPC H04N 5/23229
USPC 348/231.4

(57) ABSTRACT

An electronic camera includes two or more microphones. Two or more microphones are attached to a camera housing respectively corresponding to two or more opening portions. A detector detects an opening portion blocked by a foreign substance from among the two or more opening portions. A corrector corrects a sound acquired by a microphone corresponding to the opening portion detected by the detector out of the two or more microphones restrictively in a period during which a predetermined camera behavior is executed.

### CROSS REFERENCE OF RELATED APPLICATION

The disclosure of Japanese Patent Application No. 2012-40282, which was filed on Feb. 27, 2012, is incorporated herein by reference.

### BACKGROUND OF THE INVENTION

1. Field of the Invention

The present invention relates to an electronic camera, and in particular, relates to an electronic camera which records an external sound.

2. Description of the Related Art

According to one example of an apparatus applicable to this type of camera, directly compared are a signal of a first microphone arranged near a speaker for reproducing a high-pitched sound and an output signal a second microphone arranged near a speaker for reproducing a middle-low-pitched sound installed at a front door of a vehicle. An amplification factor of a variable gain amplifier is changed so that signal levels of which both signals are respectively integrated become equal.

However, in the above-described apparatus, the amplification factor of the variable gain amplifier is changed so that signal levels of which two sound signals are respectively integrated become equal, and therefore, there is a possibility that a normal sound is corrected when an abnormality has occurred in one of the sounds acquired by one or at least two microphones. Thereby, a sound quality may be deteriorated.

### SUMMARY OF THE INVENTION

An electronic camera according to the present invention comprises: two or more microphones which are attached to a camera housing respectively corresponding to two or more opening portions; a detector which detects an opening portion blocked by a foreign substance from among the two or more opening portions; and a corrector which corrects a sound acquired by a microphone corresponding to the opening portion detected by the detector out of the two or more microphones restrictively in a period during which a predetermined camera behavior is executed.

According to the present invention, a sound correction program recorded on a non transitory recording medium in order to control an electronic camera provided with two or more microphones which are attached to a camera housing respectively corresponding to two or more opening portions, the program causing a processor of the electronic camera to perform the steps comprises: a detecting step of detecting an opening portion blocked by a foreign substance from among the two or more opening portions; and a correcting step of correcting a sound acquired by a microphone corresponding to the opening portion detected by the detecting step out of the two or more microphones restrictively in a period during which a predetermined camera behavior is executed.

According to the present invention, a sound correction method executed by an electronic camera provided with two or more microphones which are attached to a camera housing respectively corresponding to two or more opening portions, comprises: a detecting step of detecting an opening portion blocked by a foreign substance from among the two or more opening portions; and a correcting step of correcting a sound acquired by a microphone corresponding to the opening portion detected by the detecting step out of the two or more microphones restrictively in a period during which a predetermined camera behavior is executed.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an installation state of a microphone applied to the embodiment in FIG. 2;

FIG. 4 is an illustrative view showing one example of a state where a microphone hole is blocked;

FIG. 5 is an illustrative view showing one example of an installation state of a contact sensor applied to the embodiment in FIG. 2;

FIG. 6 is a flowchart showing one portion of behavior of a CPU applied to the embodiment in FIG. 2;

FIG. 7 is a flowchart showing another portion of the behavior of the CPU applied to the embodiment in FIG. 2;

FIG. 8 is a flowchart showing still another portion of the behavior of the CPU applied to the embodiment in FIG. 2;

FIG. 9 is a block diagram showing a configuration of another embodiment of the present invention;

FIG. 10 is a flowchart showing one portion of behavior of a CPU applied to the embodiment in FIG. 9;

FIG. 11 is a block diagram showing a configuration of still another embodiment of the present invention;

FIG. 12 (A) is an illustrative view showing one example of a frequency characteristic of a sound acquired by the microphone;

FIG. 12 (B) is an illustrative view showing another example of the frequency characteristic of the sound acquired by the microphone;

FIG. 13 is a flowchart showing one portion of behavior of a CPU applied to the embodiment in FIG. 11; and

FIG. 14 is a block diagram showing a configuration of yet another embodiment of the present invention.

### DETAILED DESCRIPTION OF THE PREFERRED EMBODIMENTS

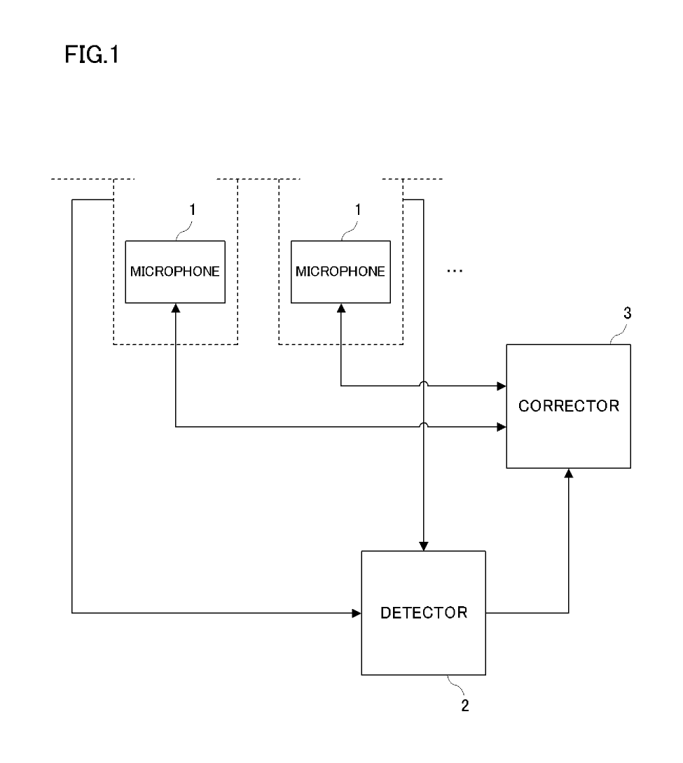

With reference to FIG. 1, an electronic camera according to one embodiment of the present invention is basically configured as follows: Two or more microphones 1, 1, . . . are attached to a camera housing respectively corresponding to two or more opening portions. A detector 2 detects an opening portion blocked by a foreign substance from among the two or more opening portions. A corrector 3 corrects a sound acquired by a microphone corresponding to the opening portion detected by the detector 2 out of the two or more microphones 1, 1, . . . restrictively in a period during which a predetermined camera behavior is executed.

When the opening portion to which the microphone is directed is blocked by the foreign substance during execution of the predetermined camera behavior, the sound of the microphone corresponding to the blocked opening portion is corrected. Thus, even if a mechanical noise is generated by the camera behavior, it is possible to prevent a deterioration of a sound quality resulting from the opening portion having been blocked, and therefore, the sound quality is improved.

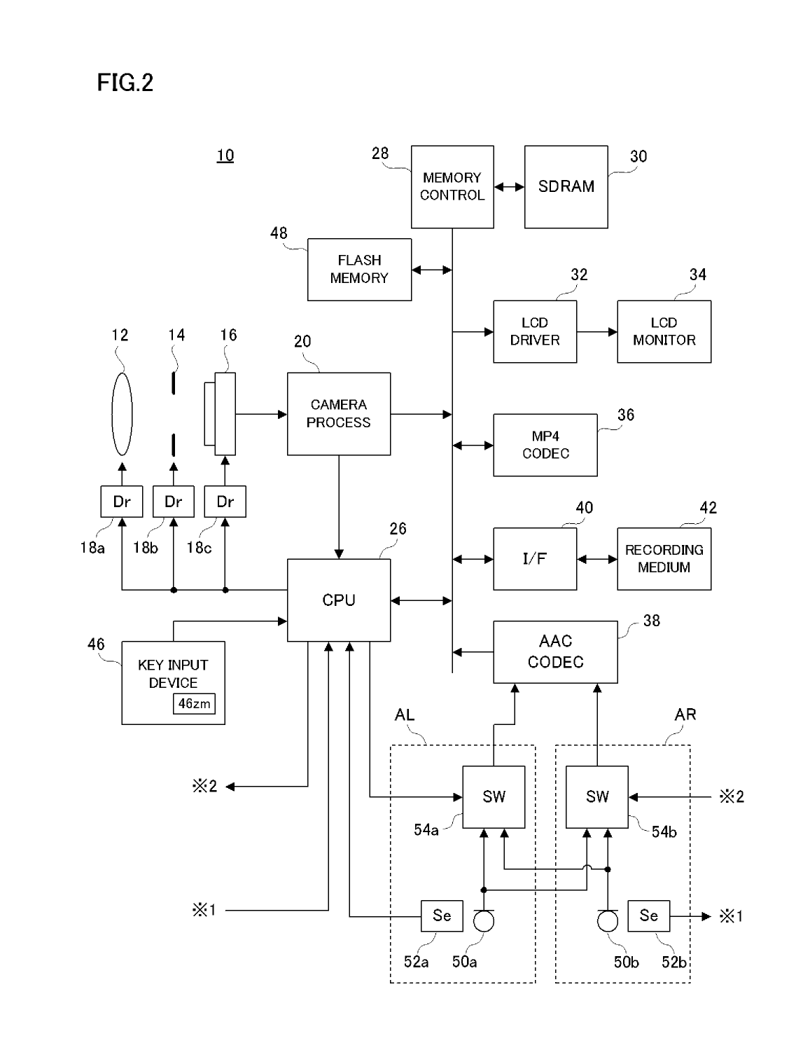

With reference to FIG. 2, a digital video camera 10 according to one embodiment includes a focus lens 12 and an aperture unit 14 driven by drivers 18a and 18b, respectively. An optical image that underwent these components enters, with irradiation, an imaging surface of an image sensor 16, and is subjected to a photoelectric conversion.

When a power source is applied, in order to execute a moving-image taking process, a CPU 26 commands a driver 18c to repeat an exposure procedure and an electric-charge reading-out procedure under an imaging task. In response to a vertical synchronization signal Vsync outputted from an SG (Signal Generator) not shown, the driver 18c exposes the imaging surface of the image sensor 16 and reads out the electric charges produced on the imaging surface of the image sensor 16 in a raster scanning manner. From the image sensor 16, raw image data that is based on the read-out electric charges is cyclically outputted.

A camera processing circuit 20 performs processes, such as digital clamp, pixel defect correction, gain control, a color separation, a white balance adjustment, a YUV conversion and etc., on the raw image data outputted from the image sensor 16 so as to create image data that comply with the YUV format. The image data is written into an SDRAM 30 through a memory control circuit 28.

An LCD driver 32 repeatedly reads out the image data stored in the SDRAM 30 through the memory control circuit 28, and drives an LCD monitor 34 based on the read-out image data. As a result, a real-time moving image (a live view image) representing a scene is displayed on the LCD monitor 34.

When a recording start operation is performed toward a key input device 46, in order to start the recording process, the CPU 26 activates an MP4 codec 36, an AAC codec 38 and an I/F 40 under the imaging task. The I/F 40 accesses a recording medium 42 so as to newly create a moving image file onto the recording medium 42 (the created moving-image file is opened).

Upon completion of the process for creating and opening the file, the CPU 26 commands the MP4 codec 36 to start an MP4 encoding process, and commands the AAC codec 38 to start an AAC encoding process.

The MP4 codec 36 repeatedly reads out the image data stored in the SDRAM 30 through the memory control circuit 28, encodes the read-out image data according to the MP4 format, and writes the encoded image data, i.e., MP4 data into the SDRAM 30 through the memory control circuit 28.

The AAC codec 38 encodes audio data outputted from a left-side audio system AL and a right-side audio system AR respectively including microphones 50a and 50b according to the AAC format, and writes the encoded audio data, i.e., AAC data into the SDRAM 30 through the memory control circuit 28.

Thereafter, the CPU 26 transfers the latest 60 frames of MP4 data and the latest one second of AAC data to a moving image file in an opened state at every time 60 frames of the MP4 data is obtained. The latest 60 frames of the MP4 data and the latest one second of the AAC data are read out from the SDRAM 30 by the memory control circuit 28 so as to be written into the moving image file through the I/F 40.

When a moving-image recording-end operation is performed toward the key input device 46, the CPU 26 commands the MP4 codec 36 to stop the MP4 encoding process and commands the AAC codec 38 to stop the AAC encoding process, and thereafter, executes a remained-data transfer process. Less than 60 frames of the MP4 data and less than one second of the AAC data remaining in the SDRAM 30 are written into the moving image file by the remained-data transfer process. The moving image file in the opened state is closed after the remained-data transfer process is completed. Thereafter, the CPU 26 stops the MP4 codec 36, the AAC codec 38 and the I/F 40 under the imaging task.

When a zoom operation is performed toward a zoom switch 46zm, under the imaging task, the CPU 26 calculates a zoom magnification by an optical zoom process based on a zoom magnification before the zoom operation and an operation to the zoom switch 46zm. The CPU 26 executes an optical zoom-in process or an optical zoom-out process by moving the zoom lens 12 in an optical-axis direction through the driver 18a based on the calculated zoom magnification. As a result, magnifications of a live view image and a recorded image are changed depending on the zoom operation.

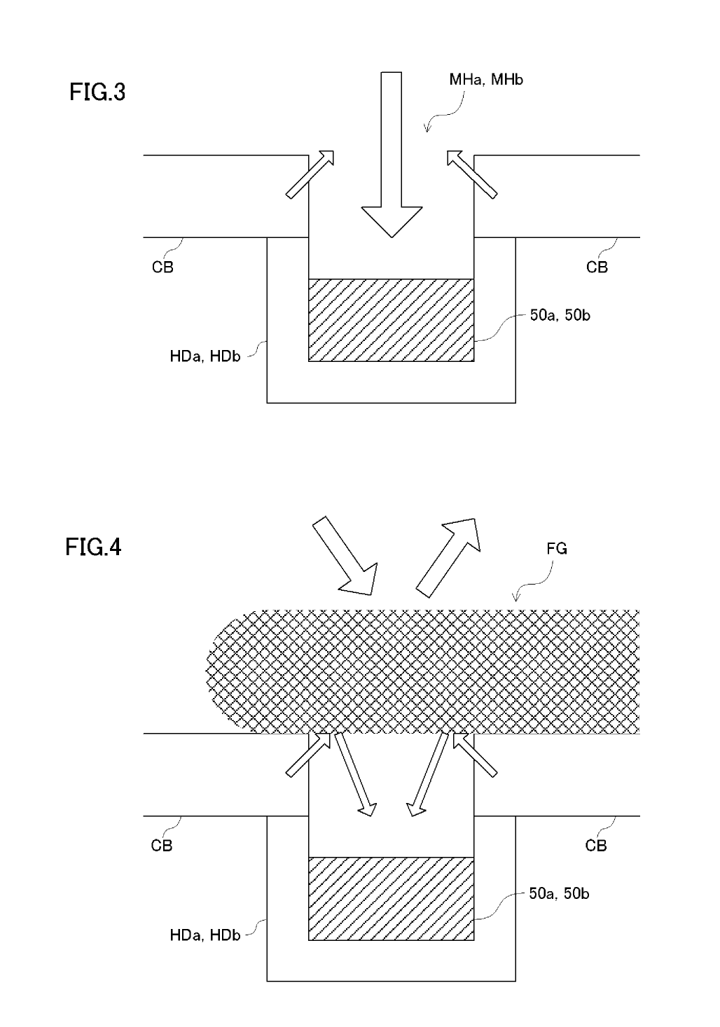

With reference to FIG. 3, microphone holes MHa and MHb are arranged in a housing CB of the digital video camera 10. Microphone holders HDa and HDb are respectively installed on internal sides of the microphone holes MHa and MHb. The microphones 50a and 50b are respectively attached to the microphone holders HDa and HDb so as to be possible to acquire external sounds through the microphone holes MHa and MHb.

During execution of the optical zoom-in process or the optical zoom-out process, a mechanical noise generated by moving the zoom lens 12 leaks from the microphone holes MHa and MHb through the housing CB. Generally, the mechanical noise leaked from the microphone holes MHa and MHb is diffused also to an outside of the housing CB, and mechanical noises acquired by the microphones 50a and 50b do not become a problem because of a sound volume difference from sounds around the digital video camera 10.

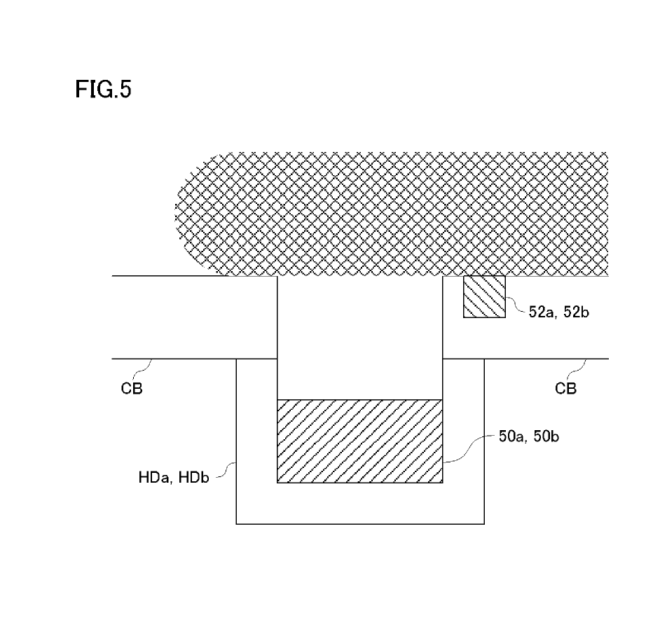

However, with reference to FIG. 4, when the microphone hole MHa or MHb is blocked by a finger FG of an operator of the digital video camera 10, a following problem occurs. That is, most of the sounds around the digital video camera 10 are muffled by the finger FG, and therefore, a sound volume acquired by the microphone 50a or 50b becomes lower. On the other hand, the mechanical noise leaked from the microphone hole MHa or MHb is interrupted to be diffused to the outside of the housing CB by the finger FG of the operator, and therefore, the sound volume acquired by the microphone 50a or 50b becomes louder. Thus, a sound acquired by a microphone in which the microphone hole is blocked out of the microphones 50a and 50b has a high percentage of the mechanical noise and has a low quality.

In contrary, contact sensors 52a and 52b are arranged in the housing CB as shown in FIG. 5, respectively close to the microphone holes MHa and MHb. The left-side audio system AL is configured by the microphone 50a, the contact sensor 52a and a switch 54a described later, and the right-side audio system AR is configured by the microphone 50b, the contact sensor 52b and a switch 54b described later.

The contact sensors 52a and 52b detect a contact of an object, and transmit a detection result to the CPU 26. Thus, when the microphone hole MHa or MHb is blocked by the finger FG of the operator, a contact of the finger FG is detected by the contact sensor 52a or 52b. It is noted that, instead of the contact sensors 52a and 52b, may be used is a nearby sensor which detects presence or absence of an adjacent object without contact.

The CPU 26 executes following processes by using the contact sensors 52a and 52b. When the contact sensor 52a detects the contact of the object, under an abnormality detecting task executed in parallel with the imaging task, the CPU 26 sets a flag FLG_L to “1” in order to declare that the microphone hole MHa is blocked. Similarly, when the contact sensor 52b detects the contact of the object, the CPU 26 sets a flag FLG_R to “1” in order to declare that the microphone hole MHb is blocked.

Moreover, under a sound correcting task executed in parallel with the imaging task, the CPU 26 repeatedly determines whether or not the optical zoom process is being executed, i.e., whether or not the mechanical noise is generated.

When the optical zoom process is being executed, the CPU 26 determines whether or not the flag FLG_L is set to “1” and the flag FLG_R is set to “0”. When a determined result is positive, it is assumed that only the microphone hole MHa is blocked by the finger FG out of the microphone holes MHa and MHb and thereby an abnormality has occurred in the sound acquired by the microphone 50a, a sound outputted from the left-side audio system AL is corrected in a manner described below.

Each of the switches 54a and 54b inputs the sounds acquired by the microphones 50a and 50b, and outputs one of the sounds according to a command of the CPU 26. As described above, when the abnormality of the sound acquired by the microphone 50a is assumed, the CPU 26 switches output of the switch 54a to the sound acquired by the microphone 50b. Thereby, the mechanical noise is reduced from the sound outputted from the left-side audio system AL.

When the flag FLG_L is set to “0” and the flag FLG_R is set to “1”, i.e., when only the microphone hole MHb is blocked by the finger FG, a correction process is executed in a manner described below. In this case, an abnormality of the sound acquired by the microphone 50b is assumed, and therefore, the CPU 26 switches output of the switch 54b to the sound acquired by the microphone 50a. Thereby, the mechanical noise is reduced from the sound outputted from the left-side audio system AR.

When both of the flags FLG_L and FLG_R are set to “0”, the CPU 26 controls the switches 54a and 54b so that the sounds acquired by the microphones 50a and 50b are respectively outputted from the left-side audio system AL and the right-side audio system AR again. It is noted that the process for restoring the outputs of the switches 54a and 54b is executed even when the optical zoom operation is being stopped. Thus, the outputs of the switches 54a and 54b are restored at a time point at which the finger FG blocking the microphone hole MHa or MHb has left. Similarly, the process is also executed when both of the flags FLG_L and FLG_R are set to “1”, i.e., when both of the microphone holes MHa and MHb are blocked. That is, the switches 54a and 54b are controlled so that the sounds acquired by the microphones 50a and 50b are respectively outputted from the left-side audio system AL and the right-side audio system AR.

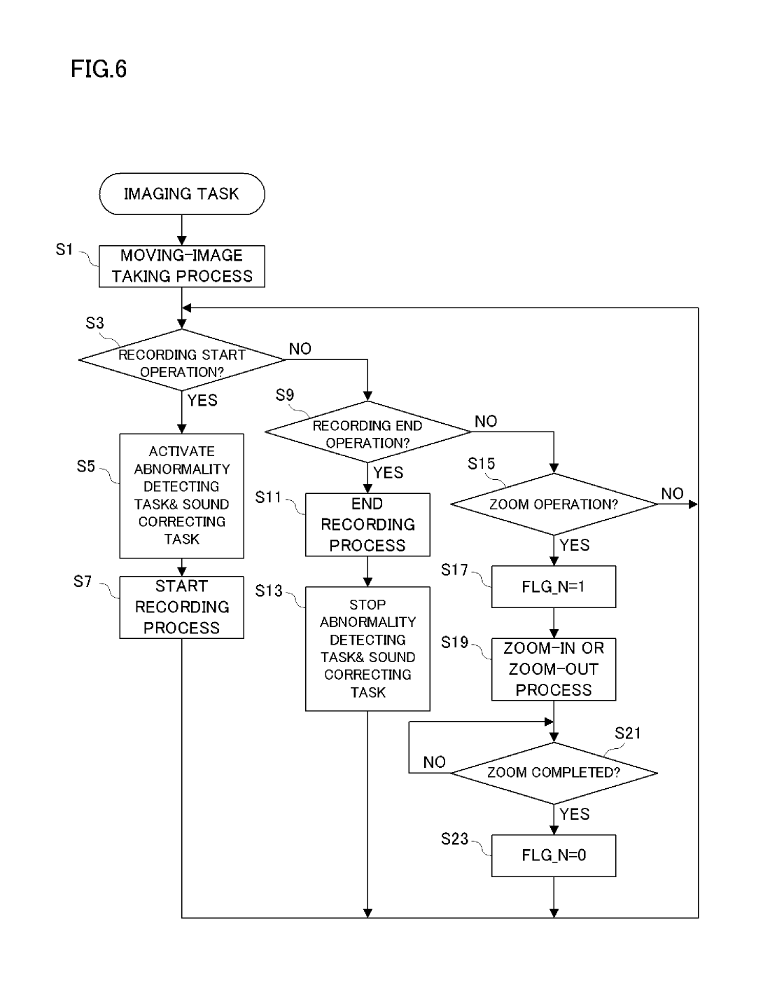

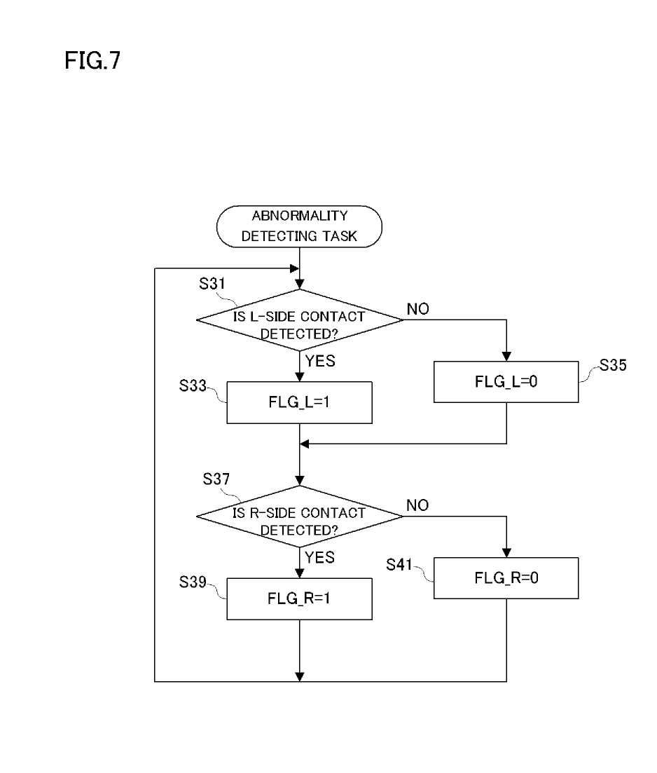

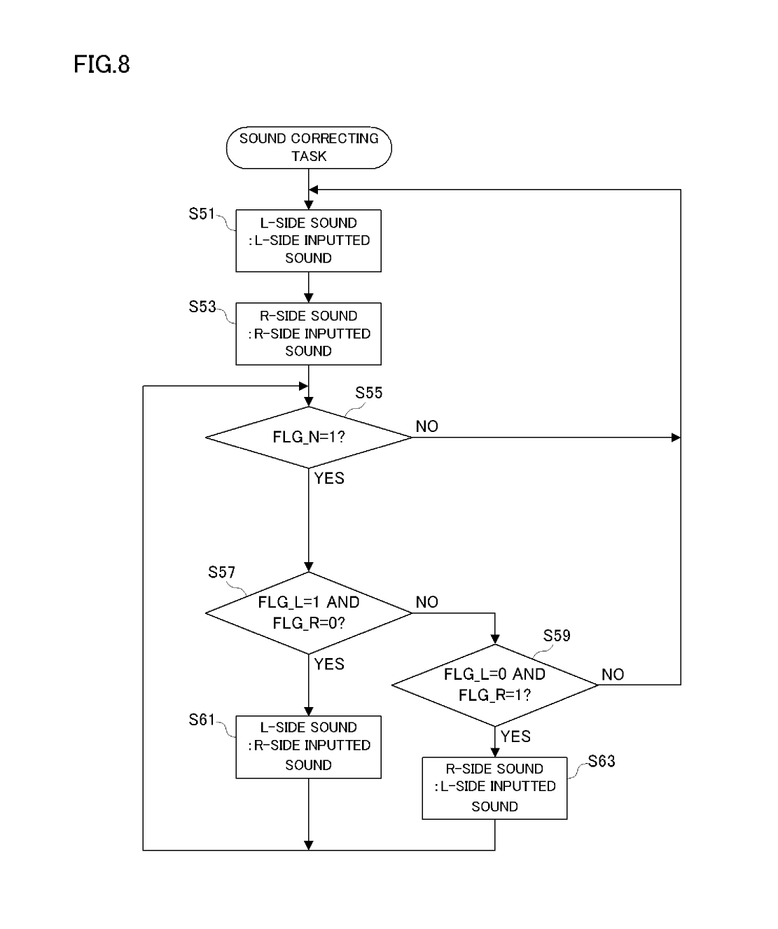

The CPU 26 performs a plurality of tasks including the imaging task shown in FIG. 6, the abnormality detecting task shown in FIG. 7 and the sound correcting task shown in FIG. 8, in a parallel manner. It is noted that control programs corresponding to these tasks are stored in a flash memory 48.

With reference to FIG. 6, in a step S1, the moving-image taking process is executed. As a result, a live view image representing a scene is displayed on the LCD monitor 34. In a step S3, it is determined whether or not the recording start operation is performed toward the key input device 46, and when a determined result is NO, the process advances to a step S9 whereas when the determined result is YES, the abnormality detecting task and the sound correcting task are activated in a step S5.

In a step S7, the MP4 codec 36, the AAC codec 38 and the I/F 40 are activated so as to start the recording process, and thereafter, the process returns to the step S3. As a result, writing MP4 data and AAC data into a moving image file created in the recording medium 42 is started.

In the step S9, it is determined whether or not the moving-image recording-end operation is performed toward the key input device 46, and when a determined result is NO, the process advances to a step S15 whereas when the determined result is YES, the process advances to a step S11.

In the step S11, the moving image file created in the recording medium 42 is closed and the MP4 codec 36, the AAC codec 38 and the I/F 40 are stopped so as to end the recording process. In a step S13, the abnormality detecting task and the sound correcting task are stopped, and thereafter, the process returns to the step S3.

In the step S15, it is determined whether or not the zoom operation is performed toward the zoom switch 46zm, when a determined result is NO, the process returns to the step S3 whereas when the determined result is YES, the process advances to a step S17. In the step S17, in order to declare that the mechanical noise is generated, the flag FLG_N is set to “1”.

In a step S19, the optical zoom-in process or the optical zoom-out process are executed, and the zoom lens 12 is moved in the optical-axis direction through the driver 18a. As a result, magnifications of a live view image and a recorded image are changed depending on the zoom operation.

In a step S21, it is determined whether or not the optical zoom process or the optical zoom-out process is completed, and when a determined result is updated from NO to YES, in a step S23, the flag FLG_N is set to “0”, and thereafter, the process returns to the step S3.

With reference to FIG. 7, in a step S31, it is determined whether or not the contact sensor 52a detects a contact of an object, and when a determined result is YES, the process advances to a step S37 via a process in a step S33 whereas when the determined result is NO, the process advances to the step S37.

In the step S33, the flag FLG_L is set to “1”, and in the step S35, the flag FLG_L is set to “0”.

In the step S37, it is determined whether or not the contact sensor 52b detects the contact of the object, when a determined result is YES, the process advances to a step S39 whereas when the determined result is NO, the process advances to a step S41.

In the step S39, the flag FLG_R is set to “1”, and in a step S41, the flag FLG_R is set to “0”. Upon completion of the process in the step S39 or S41, the process returns to the step S31.

With reference to FIG. 8, in a step S51, the switch 54a is controlled so as to output a sound acquired by the microphone 50a from the left-side audio system AL. In a step S53, the switch 54b is controlled so as to output a sound acquired by the microphone 50b from the right-side audio system AR.

In a step S55, it is determined whether or not the flag FLG_N is set to “1”, and when a determined result is NO, the process returns to the step S51 whereas when the determined result is YES, the process advances to a step S57.

In a step S57, it is determined whether or not the flag FLG_L is set to “1” and the flag FLG_R is set to “0”. When a determined result is YES, the process advances to a step S61 whereas when the determined result is NO, in a step S59, it is determined whether or not the flag FLG_L is set to “0” and the flag FLG_R is set to “1”.

When a determined result of the step S59 is NO, the process returns to the step S51 whereas when the determined result is YES, the process advances to a step S63.

In the step S61, the switch 54a is controlled so as to output the sound acquired by the microphone 50b from the left-side audio system AL. In the step S63, the switch 54b is controlled so as to output the sound acquired by the microphone 50a from the right-side audio system AR. Upon completion of the process in the step S61 or S63, the process returns to the step S55.

As can be seen from the above-described explanation, the microphones 50a and 50b are attached to the camera housing toward the two opening portions respectively. The contact sensors 52a and 52b and the CPU 26 detect the opening portion blocked by the foreign substance from among the two or more opening portions. The switches 54a and 54b and the CPU 26 correct the sound acquired by the microphone corresponding to the detected opening portion out of the microphones 50a and 50b only in the period during which the predetermined camera behavior is executed.

When one of the opening portions to which the microphones 50a and 50b are directed is blocked by the foreign substance during execution of the predetermined camera behavior, the sound of the microphone corresponding to the blocked opening portion is corrected. Thus, even if the mechanical noise is generated by the camera behavior, it is possible to prevent the deterioration of the sound quality resulting from the opening portion having been blocked, and therefore, the sound quality is improved.

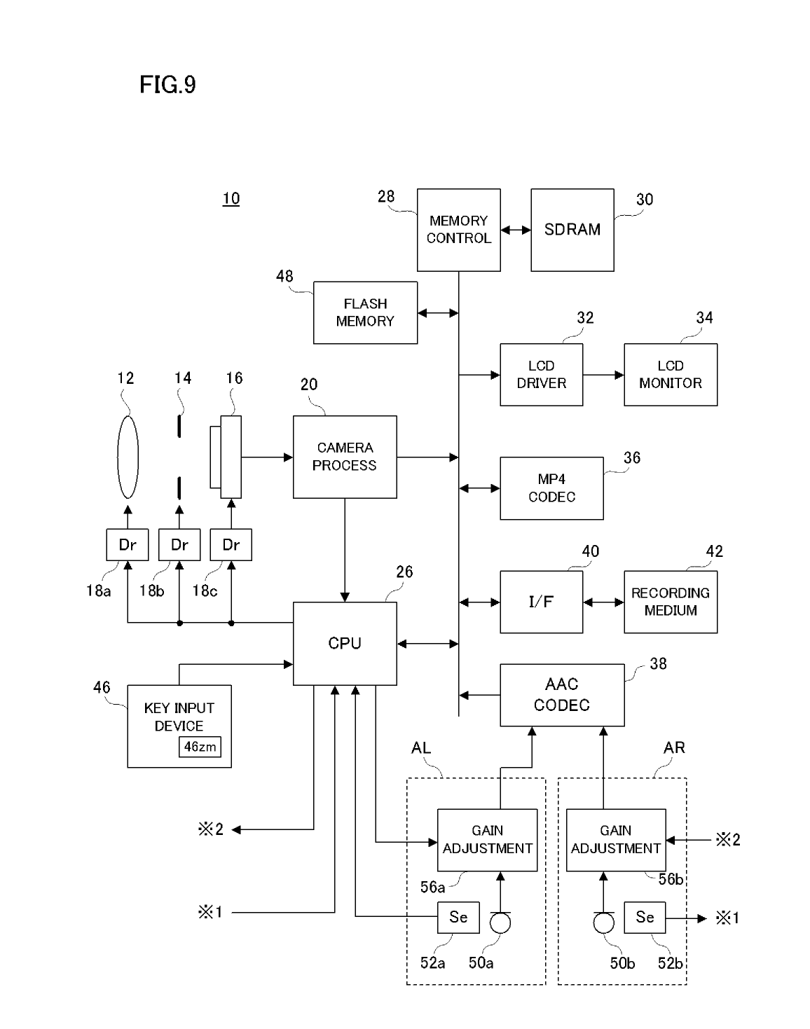

It is noted that, in this embodiment, instead of the sound assumed the abnormality, another sound is outputted by using the switches 54a and 54b to correct the sound. However, instead of the switches 54a and 54b, gain adjusting circuits 56a and 56b may be connected as shown in FIG. 9 so as to reduce a gain level of the sound assumed the abnormality.

In this case, the gain adjusting circuits 56a and 56b respectively input the sounds acquired by the microphones 50a and 50b, and adjust gain levels according to the command of the CPU 26.

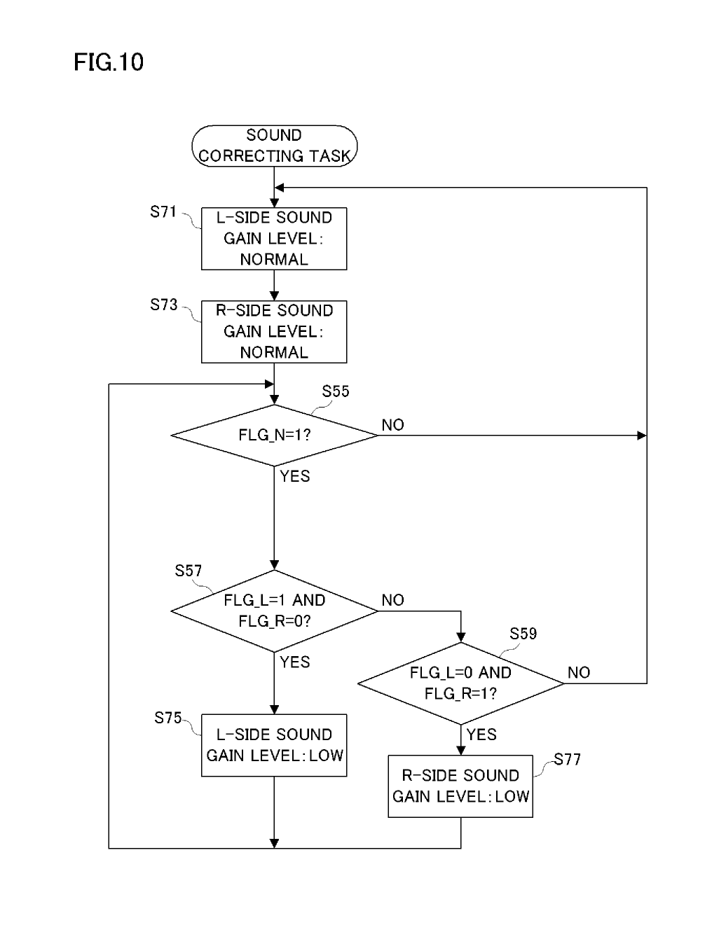

Moreover, in this case, with reference to FIG. 10, instead of the processes in the steps S51, S53, S61 and S63 shown in FIG. 8, processes in steps S71, S73, S75 and S77 are executed.

In the step S71, the gain adjusting circuit 56a is commanded to set a gain level of the left-side sound system AL to a normal level, and in the step S73, the gain adjusting circuit 56b is commanded to set a gain level of the right-side sound system AR to the normal level.

In the step S75, the gain adjusting circuit 56a is commanded to reduce the gain level of the left-side sound system AL, and in the step S77, the gain adjusting circuit 56b is commanded to reduce the gain level of the right-side sound system AR.

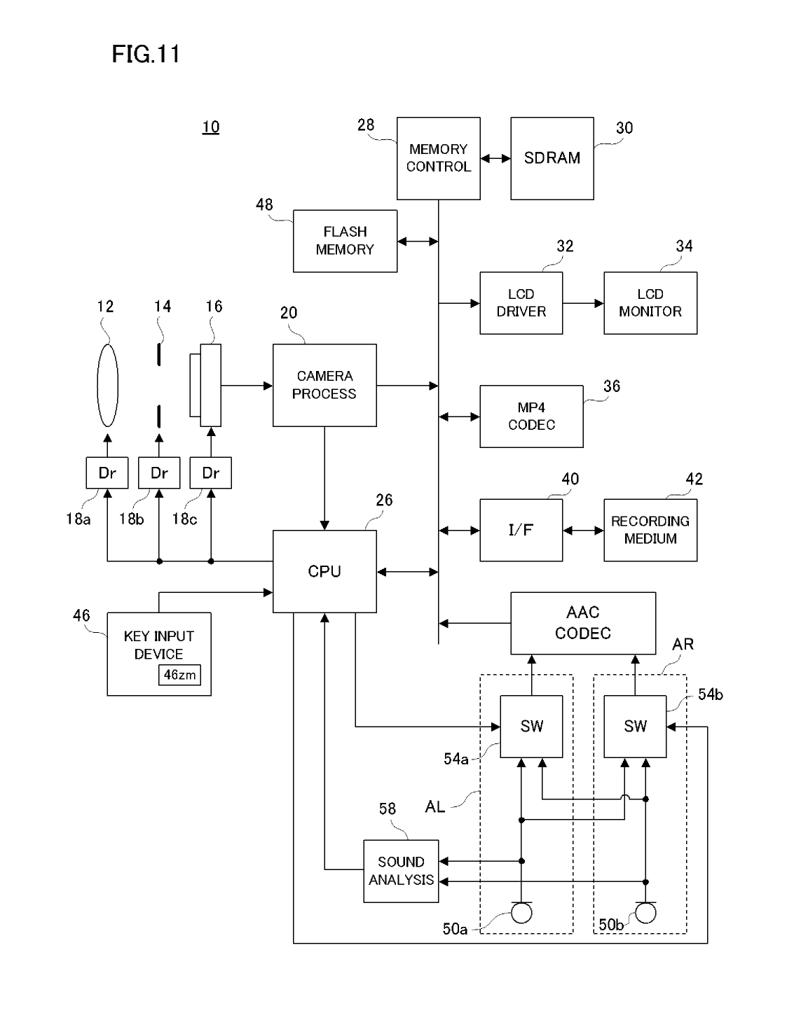

Moreover, in this embodiment, the contact sensors 52a and 52b detect that the microphone hole MHa or MHb is blocked so as to correct the sound associated with the detection. However, instead of the contact sensors 52a and 52b, a sound analyzing circuit 58 is connected as shown in FIG. 11 so as to detect that the abnormality is generated in the sound.

In this case, the sound analyzing circuit 58 inputs the sounds acquired by the microphones 50a and 50b, and detects that the abnormality is generated in the sound by performing a matching process to two inputted sounds.

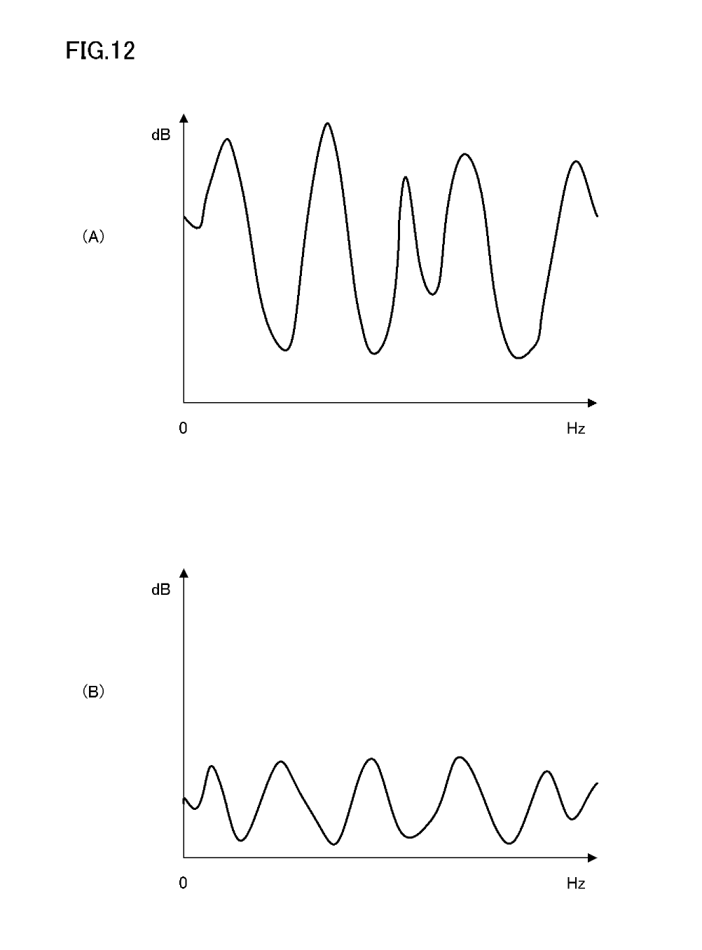

A frequency characteristic of the sounds acquired by the microphones 50a and 50 in a normal state is shown in FIG. 12 (A). In contrary, as shown in FIG. 12 (B), a frequency characteristic of the sound acquired in a state where the microphone hole MHa or MHb is blocked indicates that a recording level is deteriorated overall. Moreover, when the mechanical noise is generated, a noise component is not diffused to an outside of the microphone hole, and therefore, it is anticipated that the low-frequency component is increased. Thus, the sound analyzing circuit 58 transmits to the CPU 26 that an abnormality is generated when a difference between the sounds acquired by the microphones 50a and 50b exceeds a predetermined value as a result of the matching process.

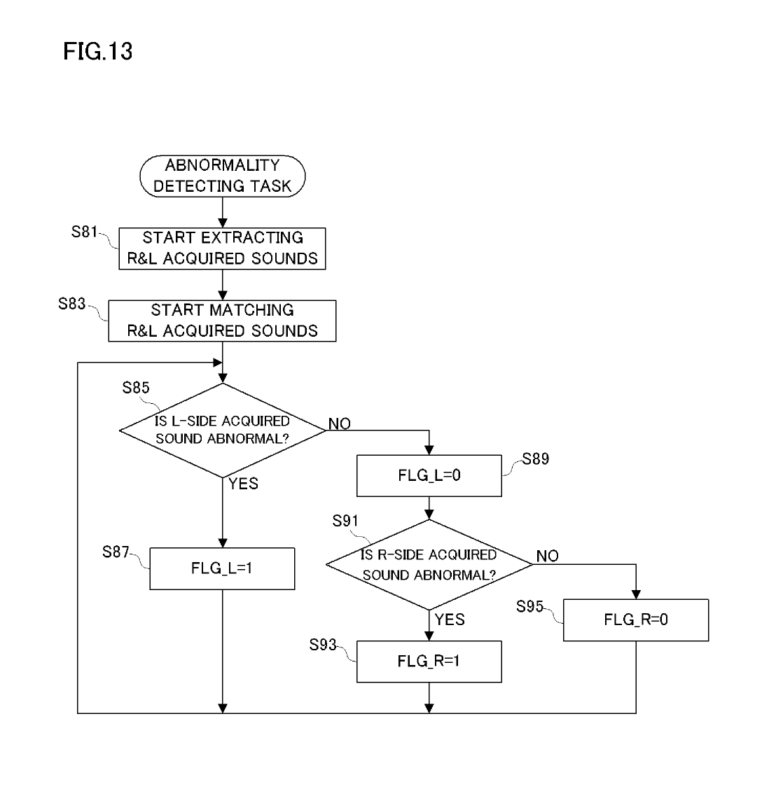

Moreover, in this case, instead of the processes shown in FIG. 7, processes shown in FIG. 13 are executed in the abnormality detecting task.

With reference to FIG. 13, in a step S81, the sound analyzing circuit 58 is activated so as to start extract the sounds acquired by the microphones 50a and 50b. In a step S83, the matching process is started for the sounds acquired by the microphones 50a and 50b.

In a step S85, it is determined whether or not an abnormality of the sound acquired by the microphone 50a is detected as a result of the matching process, and when a determined result is NO, the process advances to a step S89 whereas when the determined result is YES, the flag FLG_R is set to “1” in a step S87.

In the step S89, the flag FLG_R is set to “0”, and in a step S91, it is determined whether or not an abnormality of the sound acquired by the microphone 50b is detected.

When a determined result is YES, the flag FLG_L is set to “1” in a step S93, and when the determined result is NO, the flag FLG_L is set to “0” in a step S95. Upon completion of the process in the step S87, S93 or S95, the process returns to the step S85.

Moreover, in this embodiment, the sound outputted from the microphone is encoded by using the AAC codec. However, a coding system other than the AAC may be used. For example, systems such as the PCM (Pulse Code Modulation) and the MP3 (MPEG Audio Layer-3) may be used.

Moreover, in this embodiment, processes in the flow charts shown in FIG. 6 to FIG. 8, FIG. 10 and FIG. 13 are executed by using the CPU. However, a DSP (Digital Signal Processor) dedicated to the sound may be arranged so as to execute a part of these processes.

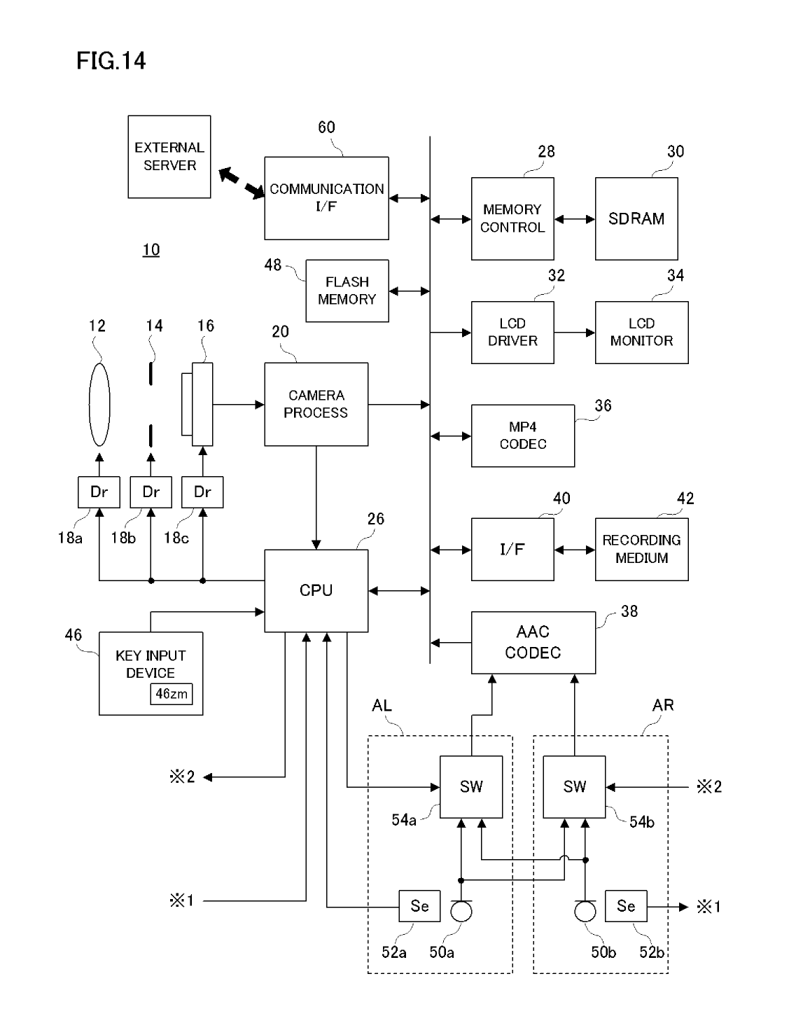

It is noted that, in this embodiment, the control programs equivalent to the multi task operating system and a plurality of tasks executed thereby are previously stored in the flash memory 48. However, a communication I/F 60 may be arranged in the digital video camera 10 as shown in FIG. 14 so as to initially prepare a part of the control programs in the flash memory 48 as an internal control program whereas acquire another part of the control programs from an external server as an external control program. In this case, the above-described procedures are realized in cooperation with the internal control program and the external control program.

Moreover, in this embodiment, the sound is corrected when one of the microphone holes MHa and MHb is blocked during execution of the optical zoom process. However, the sound may be corrected when one of the microphone holes MHa and MHb is blocked during execution of another camera behavior in which the mechanic noise is generated. For example, it also may be a target of the sound correcting process when the operator operates the key input device 46, when the focus lens 12, the aperture unit 14 or the image sensor 16 is moved according to a camera-shake correcting process and etc.

Moreover, in this embodiment, the processes executed by the CPU 26 are divided into a plurality of tasks including the imaging task shown in FIG. 6, the abnormality detecting task shown in FIG. 7 and the sound correcting task shown in FIG. 8. However, these tasks may be further divided into a plurality of small tasks, and furthermore, a part of the divided plurality of small tasks may be integrated into another task. Moreover, when a transferring task is divided into the plurality of small tasks, the whole task or a part of the task may be acquired from the external server.

Moreover, in this embodiment, the present invention is explained by using the digital video camera, however, a personal computer, cell phone units, or a smartphone may be applied to.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera comprising:
two or more microphones which are attached to a camera housing respectively corresponding to two or more opening portions;
a detector which detects an opening portion blocked by a foreign substance from among said two or more opening portions; and
a corrector which corrects a sound acquired by a microphone corresponding to the opening portion detected by said detector out of the two or more microphones restrictively in a period during which a predetermined camera behavior is executed.

2. An electronic camera according to claim 1, further comprising an imager which outputs an image representing a scene captured on an imaging surface through a focus lens, wherein the predetermined camera behavior is equivalent to a behavior of adjusting a distance between said focus lens and said imaging surface.

3. An electronic camera according to claim 1, wherein said detector includes two or more contact sensors which are arranged respectively close to said two or more opening portions and each of which detects a contact of an object.

4. An electronic camera according to claim 1, wherein said detector includes a comparer which compares the sounds acquired by said two or more microphones.

5. An electronic camera according to claim 1, wherein said corrector includes a switcher which outputs a sound acquired by another microphone instead of the sound acquired by the microphone associated with detection of said detector out of said two or more microphones.

6. An electronic camera according to claim 1, wherein said corrector includes an adjuster which adjusts a gain level of the sounds acquired by said two or more microphones in association with the detection of said detector.

7. A sound correction program recorded on a non-transitory recording medium in order to control an electronic camera provided with two or more microphones which are attached to a camera housing respectively corresponding to two or more opening portions, the program causing a processor of the electronic camera to perform the steps comprises:
a detecting step of detecting an opening portion blocked by a foreign substance from among said two or more opening portions; and
a correcting step of correcting a sound acquired by a microphone corresponding to the opening portion detected by said detecting step out of the two or more microphones restrictively in a period during which a predetermined camera behavior is executed.

8. A sound correction method executed by an electronic camera provided with two or more microphones which are attached to a camera housing respectively corresponding to two or more opening portions, comprising:
a detecting step of detecting an opening portion blocked by a foreign substance from among said two or more opening portions; and
a correcting step of correcting a sound acquired by a microphone corresponding to the opening portion detected by said detecting step out of the two or more microphones restrictively in a period during which a predetermined camera behavior is executed.
